(19) United States
(12) Patent Application Publication
(10) Pub. No.: US 2016/0063215 A1
(43) Pub. Date: Mar. 3, 2016

(54) TRAVEL HEALTH MANAGEMENT SYSTEM

(71) Applicant: EBAY INC., San Jose, CA (US)

(72) Inventor: Kamal Zamer, San Jose, CA (US)

(21) Appl. No.: 14/473,616

(22) Filed: Aug. 29, 2014

(51) Int. Cl. G06F 19/00

(52) U.S. Cl. CPC G06F 19/3481; G06F 19/322

(57) ABSTRACT

Systems and methods for providing travel health management include determining that a user will be traveling to a new location that is different from a home location that is associated with the user in a database. Health situation information that is associated with at least one health situation at the new location is then retrieved. The health situation information is compared to a medical profile for the user that is stored in the database to determine a travel health recommendation that includes a health action that will prepare the user for the at least one health situation at the new location. The travel health recommendation is then provided for display to the user. A status of the performance of the heath action by the user may then be tracked, and updates displayed to the user to provide for the management of the travel health of the user.

### BACKGROUND

1. Field of the Disclosure

The present disclosure generally relates to personal health, and more particularly to a travel health management system for assisting a user in managing health situations related to traveling to new locations.

2. Related Art

Management of a person's health can be complicated, particularly with regard to traveling to new locations in which the person may experience health situations that they do not experience in their home location. For example, depending on the new location to which the person travels to, vaccinations, medications, immunizations, and/or other medical treatments may be required or recommended so that the person does not experience negative health effects such as disease, sickness, and/or other ailments known in the art. Conventionally, the determination of possible health situations and the preparations and/or treatments needed to deal with those possible health situations is a manual and complicated process that requires the person to attempt to determine what possible health situations may exist at a new location they're traveling to, find medical service providers at which preparations and/or treatments may be obtained to deal with those possible health situations, and then ensure those preparations and/or treatments are completed prior to the travel to the new location. Such conventional methods are inaccurate, as a person may have trouble finding out the most relevant and current health situations associated with a new location, and require a level of scheduling and/or tracking that most people are unwilling and/or unable to perform. As such, many people travel to new locations unprepared for the potential health situations and, in many cases, contract sickness, disease, or other ailments as a result.

Thus, there is a need for an improved travel health management system.

### BRIEF DESCRIPTION OF THE FIGURES

FIG. 1 is a flow chart illustrating an embodiment of a method for managing the travel health of a user;

FIG. 2 is a schematic view illustrating an embodiment of travel health management system;

FIG. 3 is a screen shot illustrating an embodiment of a travel health reporting screen;

FIG. 4 is a screen shot illustrating an embodiment of a travel detection and medical profile confirmation screen;

FIG. 5 is a screen shot illustrating an embodiment of a travel health status screen;

FIG. 6 is a screen shot illustrating an embodiment of a travel health recommendation screen;

FIG. 7 is a screen shot illustrating an embodiment of a travel health recommendation screen;

FIG. 8 is a screen shot illustrating an embodiment of a travel health status update screen;

FIG. 9 is a screen shot illustrating an embodiment of a travel health action reminder screen;

FIG. 10 is a screen shot illustrating an embodiment of a travel health action suggestion screen;

FIG. 11 is a schematic view illustrating an embodiment of a networked system;

FIG. 12 is a perspective view illustrating an embodiment of a user device;

FIG. 13 is a schematic view illustrating an embodiment of a computer system; and

FIG. 14 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for managing the travel health of users. As discussed above, traveling to new locations away from one's home location can present a person with health situations at those new locations that may require preparations such that the person does not experience negative health effects as a result of traveling to the new location. For example, international travel away from a person's home location may require immunizations or medications that address one or more health situations at a new location in another country. The systems and methods of the present disclosure operate to determine when a user is traveling away from their home location to a new location and, in response, determine possible health situations at the new location. The systems and methods may then compare those possible health situations to a medical profile of the user, which may be compiled by the system and/or method by tracking medical procedures or services, health related purchases, and/or other health actions taken by the user. The comparison of the possible health situations to the user's medical profile allows for the determination of health actions that should be taken by the user to prepare for the possible health situations at the new location. For example, that comparison may determine that hepatitis A is a concern at the new location and that the user has not been vaccinated for hepatitis A, and thus a health action that includes getting a vaccination for hepatitis A may be determined to prepare the user for traveling to the new location. The systems and methods may then provide a travel health recommendation to the user to get a hepatitis A vaccination. Following the provision of the travel health recommendation, the systems and methods may track the user's performance of the recommended health action (e.g., multiple booster shots over a period of months for a vaccination) to determine whether the user is on track to complete the health action, report the status of the performance of the health action, and in some situations recommend locations where the health action may be performed and send reminders to complete the health action. As such, a user traveling to a new location away from their home location may have their travel health status determined, updated, monitored, and managed so that the user will be prepared for traveling to the new location without experiencing negative health effects.

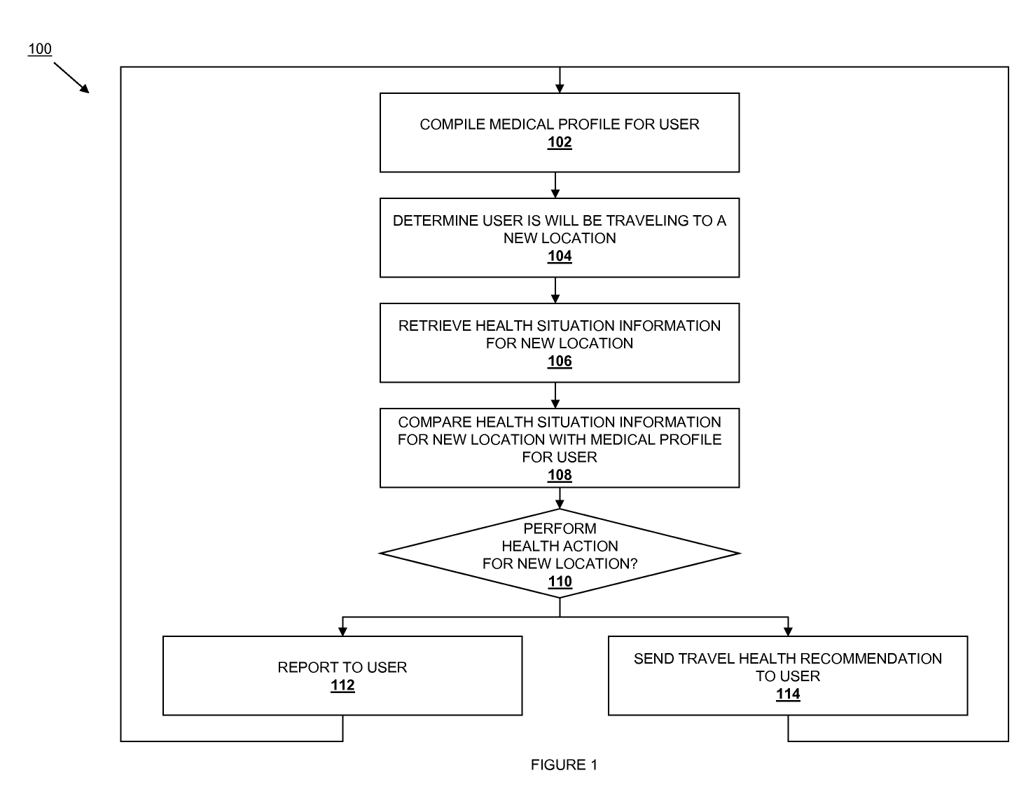

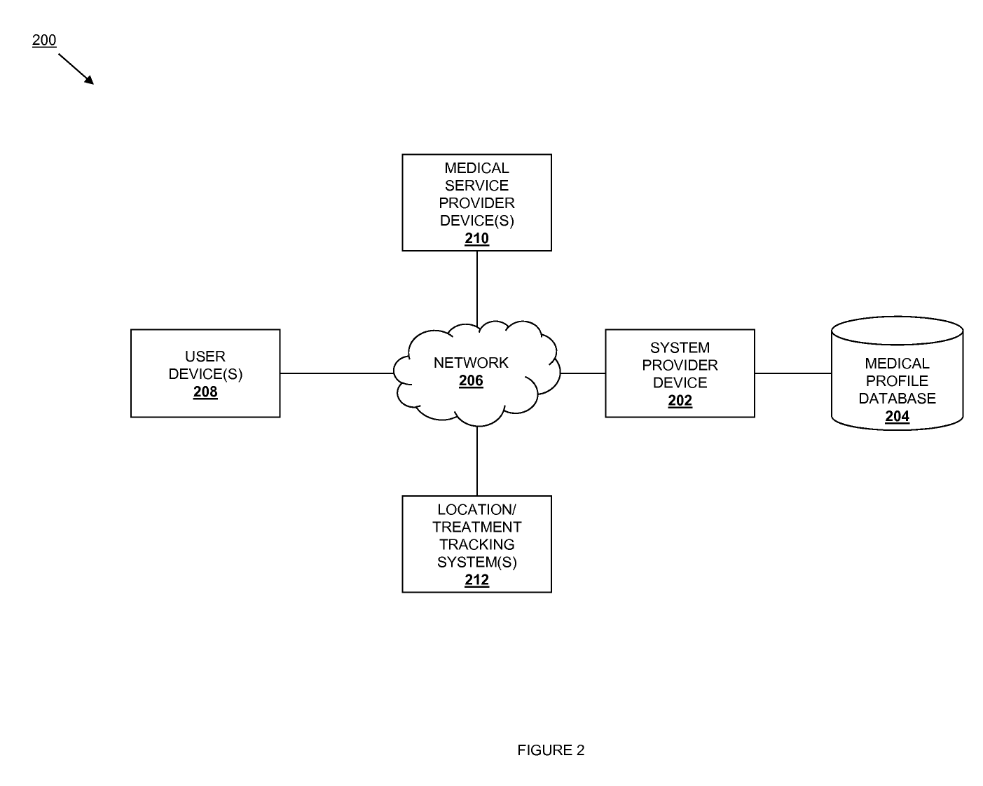

Referring now to FIGS. 1 and 2, an embodiment of a method 100 for managing travel health and an embodiment of a travel health management system 200 for performing that method 100 are illustrated. The travel health management system 200 includes a system provider device 202 that is coupled to a medical profile database 204 and a network 206. In the embodiments discussed below, the system provider device 202 may be operated by a payment service provider such as, for example, PayPal Inc. of San Jose, Calif., that provides payment services for users and merchants (e.g., the medical service providers discussed below) by providing payment service accounts that may be funded using funding accounts provided by funding account providers (e.g., bank account providers, credit account providers, the payment service provider, etc.). As such, the payment service provider may operate a payment service provider device/system provider device to facilitate transactions between users (via their user payment service accounts) and merchants (via their merchant payment service accounts) by transferring funds between their associated accounts for purchases. However, other system providers including medical service providers, insurance service providers, government entities, and/or other system providers known in the art may operate the system provider device while remaining within the scope of the present disclosure. While the medical profile database 204 is illustrated as a single database that is directly coupled to the system provider device 202, the medical profile database 204 may be part of one or more combined databases (e.g., it may be one of a plurality of databases provided accessible by the system provider device 202 such as, for example, the payment databases, user databases, health situation databases, and/or other databases discussed below) and may be coupled to the system provider device 202 through the network 206.

One or more user devices 208 are coupled through the network 206 to the system provider device 202. In the examples below, the user devices 208 are illustrated and described as mobile phones, but desktop computers, tablet computers, wearable computers, and/or any other computing system known in the art may be utilized as a user device while remaining within the scope of the present disclosure. One or more medical service provider devices 210 are coupled through the network 206 to the system provider device 202 and may include mobile computers, desktop computers, tablet computers, wearable computers, server computers, and/or any other computing system known in the art. One or more location/treatment tracking systems 212 are coupled through the network 206 to the system provider device 202 and may include mobile computers, desktop computers, tablet computers, wearable computers, server computers, and/or any other computing system known in the art. While a few devices and systems are illustrated in the example of the travel health management system 200 of FIG. 2, other devices and systems may interact with the system provider device 202 to provide more advanced functionality (e.g., the governmental entity devices discussed below) while remaining within the scope of the present disclosure.

In the embodiments discussed below, the system provider may provide an application and/or website that is executable and/or accessible by the user devices 208 to allow for the functionality of the user devices 208 (e.g., the provision of the screens, the interactions between the user devices 208 and system provider devices 202, and/or any of the other functionality discussed below). However, other entities may provide the applications and/or websites accessed by the user devices 208 while remaining within the scope of the present disclosure. Furthermore, information provided by the user devices 208 or retrieved by the system provider device 202 via the applications and/or websites may, at least on some cases, be provided or retrieved in other manners while remaining within the scope of the present disclosure.

Referring now to FIGS. 1 and 2, the method 100 begins at block 102 where a medical profile for a user is compiled. At block 102, the system provider device 202 may retrieve medical information for users through the network 206 and store that medical information associated with its respective user as medical profiles in the medical profile database 204. While several examples of compiling medical profiles are described below, one of skill in the art in possession of the present disclosure will recognize that a wide variety of different medical profile compiling techniques will fall within the scope of the present disclosure. In addition, while not detailed below, security procedures, encryption, and authorization techniques may be utilized to ensure that any medical and/or other sensitive user information that is transmitted and stored in the travel health management system 200 is safe from unauthorized access.

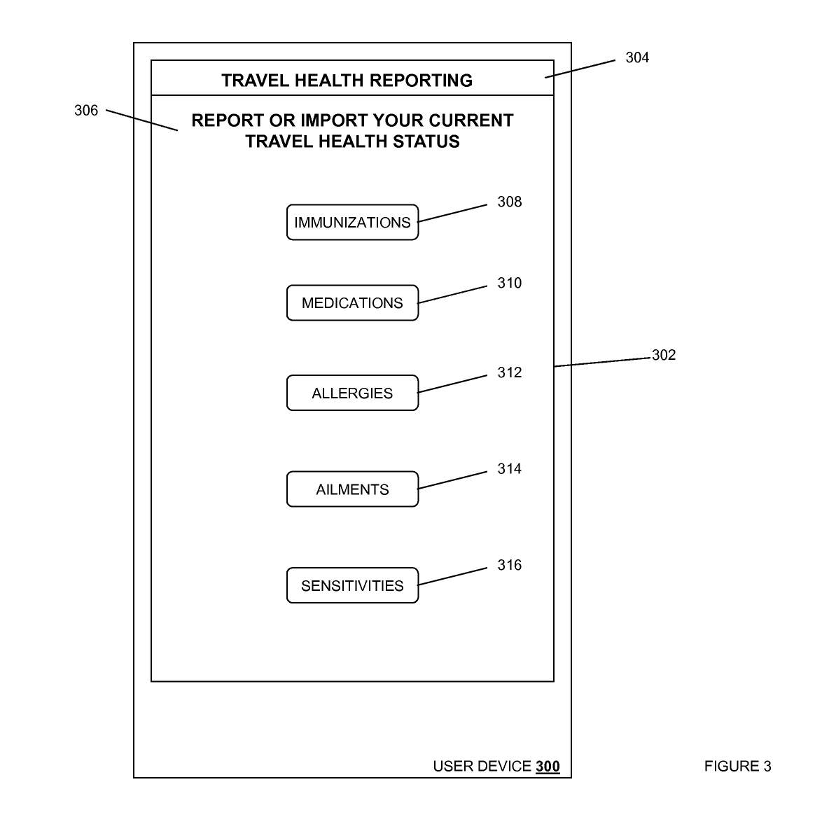

In an embodiment, the system provider device 202 may receive medical information from a user device 208 of a user and store that medical information in the medical profile database 204 as a medical profile for that user. For example, FIG. 3 illustrates an embodiment of a user device 300, which may be any of the user devices 208 discussed above with reference to FIG. 2, that includes a display device 302 displaying a travel health reporting screen 304. As discussed above, the travel health reporting screen 304 may be provided by an application running on the user device 300, a website accessed using the user device 300, and/or in a variety of other manners known in the art. As such, the user may be associated with a travel health management account and may include travel health management account credentials that the user may provide (via the user device 300) to the system provider device 202 to access the travel health reporting screen 304 and any of the other screens discussed below.

The travel health reporting screen 304 includes an instruction 306 to report or import a current travel health status, along with an immunization selector 308, a medications selector 310, an allergies selector 312, an ailments selector 314, and a sensitivities selector 316. A user of the user device 300 may use the travel health reporting screen 304 to select the immunization selector 308 to report or import immunizations that have been previously received by the user, to select the medications selector 310 to report or import current medications the user is taking or has access to, to select the allergies selector 312 to report allergies experienced by the user, to select the ailments selector 314 to report ailments (e.g., asthma, recent open wounds, etc.) currently being experienced by the user, and to select the sensitivities selector 316 to report or import any other ailments associated with the user.

While not illustrated, the selection of any of the selectors 308-316 may provide the user with one or more addition screens that provide for the provision of medical information to the system provider device 202 for compiling the medical profile at block 102. For example, any of the selectors 308-316 may provide menus, buttons, drop-down inputs, text inputs, and/or other information provisioning tools that allow a user to provide any details of medical information they would like (e.g., a drop down menu for a plurality of immunizations the user may have received, along with the ability to provide a date the immunizations was received, etc.). Furthermore, any of the selectors 308-316 may provide the ability for the user to connect to a medical service provider (e.g., via the medical service devices 210) to import their medical information to the system provider device 202. Thus, at block 102, the system provider device 202 may receive medical information through the network 206 from a user through their user device 208 and, in response, may store that medical information in a medical profile for that user in the medical profile database 204.

In another embodiment, the system provider may receive permission from a user to retrieve medical information of that user directly from their medical service provider, and in response the system provider device 202 may connect to a medical service provider device 210 through the network 206 to retrieve medical information for the user and store that medical information in a medical profile for that user in the medical profile database 204. In some embodiments, the importing of medical information (from the medical service provider device 210 to the system provider device 202 based on instructions by the user device 208, from the medical service provider device to the system provider device 202 based on permissions provided by the user to the service provider device 202, etc.) may include limiting access to medical information that is pertinent to travel health. For example, access to medical information for importation may be limited to immunizations received, travel related medications purchased, user ailments that affected by location, etc. However, in other examples, the medical profile compiled by the system provider device 202 may be compiled with access to a complete medical history of the user.

In another embodiment, a purchase history or purchases by a user may be used by the system provider device 202 to determine medical information for that user that is stored in a medical profile for that user in the medical profile database 204. For example, as discussed above, the system provider may be a payment service provider that has access to a payment service account of the user, and the payment service provider device/system provider device 202 may access the payment service account of the user to determine purchases made by the user for medical services. As such, the system provider device 202 may determine when the user has made purchases for medications, immunizations, medical treatments, medical check-ups, and/or other health actions. Those medical service based purchases may then be considered medical information for that user, and may be stored as part of a medical profile for the user in the medical profile database 204. In different embodiments, the purchases that will be considered medical information may include any information about any of a wide variety of health actions performed by the user. For example, medical insurance charge codes may be included in a purchase history of a user, and those medical service charge codes may be interpreted by the system provider device 202 to determine medical services or that have been received by a user and/or medical purchases made by the user.

Thus, at block 102, the system provider device 202 may communicate over the network with user devices 208 and/or the medical service provider devices 210, and/or may review purchase histories of users, in order to retrieve medical information for any number of users, associate each user with their retrieved medical information as medical profiles for those users, and store those medical profiles in the medical profile database 204. As such, the system provider device 202 may compile or otherwise build up medical profiles for each user in the travel health management system 200. While in some embodiments the user may be involved in providing medical information for their medical profile, in other embodiments, the system provider device 202 may receive permission to compile the medical profile of the user from that user, and then may compile that medical profile without interaction from the user. In yet other embodiments, a user may be asked to update their medical profile if they are about to travel (e.g., as detected at block 104, discussed below) or at any other time (e.g., when they log into their travel health management account) using, for example, the travel health reporting screen 304 illustrated and discussed above with reference to FIG. 3.

In some embodiments, the user may opt to associate their medical profile that is compiled and stored by the system provider device 202 with user documentation. For example, a user may include travel documentation such as, for example, a passport, a driver's license, an identification card, and/or other travel documentation known in the art, and the user may provide (e.g., via the user device 208 through their travel health management account) a travel documentation identifier to the system provider device 202 so that the system provider device 202 may associate that travel documentation identifier with the medical profile of the user in the medical profile database 204. Such associations of the user's travel documentation with the medical profile of the user may be accompanied by an instruction, permission, and/or authorization from the user to provide the medical profile to other systems in response to receiving the travel documentation identifier.

Systems such as, for example, governmental entity systems that may include customs systems, immigration systems, and/or other governmental health systems known in the art, may be registered with the system provider device 202 in order to obtain access to medical profiles of users. As such, those registered systems may utilize the travel documentation identifier on a user's travel documentation (i.e., presented by a user when entering a country or other location) in order to request a medical profile for that user from the system provider device 202. Upon determining that such registered systems are authorized to retrieve the medical profile of the user, the system provider device may then retrieve that medical profile using the travel documentation identifier and provide it over the network 206 to the registered system. In some embodiments, the system provider device 202 may determine what information in a medical profile of a user may be provided to a registered system (e.g., a governmental entity customs system) based on health requirements associated with that registered system (e.g., based on required or recommended immunizations, medications, etc., discussed below). As such, the travel health management system 200 may be utilized to share medical profile information of a user with a governmental entity in order to allow the governmental entity to quickly ensure that the user is prepared to enter their country, and ease the entrance into that country for the user.

The method 100 then proceeds to block 104 where it is determined that a user will be traveling to a new location. In an embodiment, the system provider device 202 may associate each user in the travel health management system 200 with a home location in a database (e.g., a database that includes the medical profile database 204 or other similar databases accessible by the system provider device 202). In some embodiments, the home location of the user may be self-reported by the user (i.e., by the user designating a home location in their travel health management account). In other embodiments, the home location of the user may be determined by the system provider device 202 based on detected locations of the user. For example, the system provider device 202 may review a plurality of previously received locations from the user device 208 of the user, a plurality of previous purchases of the user (e.g., via the purchase history discussed above), and/or other location-related information that is associated with the user to determine a home location in which the user is located more often than other locations. As such, each user in the travel health management system 100 will be associated with a home location such that travel by the user to a new location that is different than the home location (e.g. a predetermined distance from the home location) of the user may be determined at block 104. While a few examples of determining that the user is traveling to a new location are described below, one of skill in the art in possession of the present disclosure will recognize that a wide variety of different methods for determining whether a user will be traveling to a new location will fall within the scope of the present disclosure.

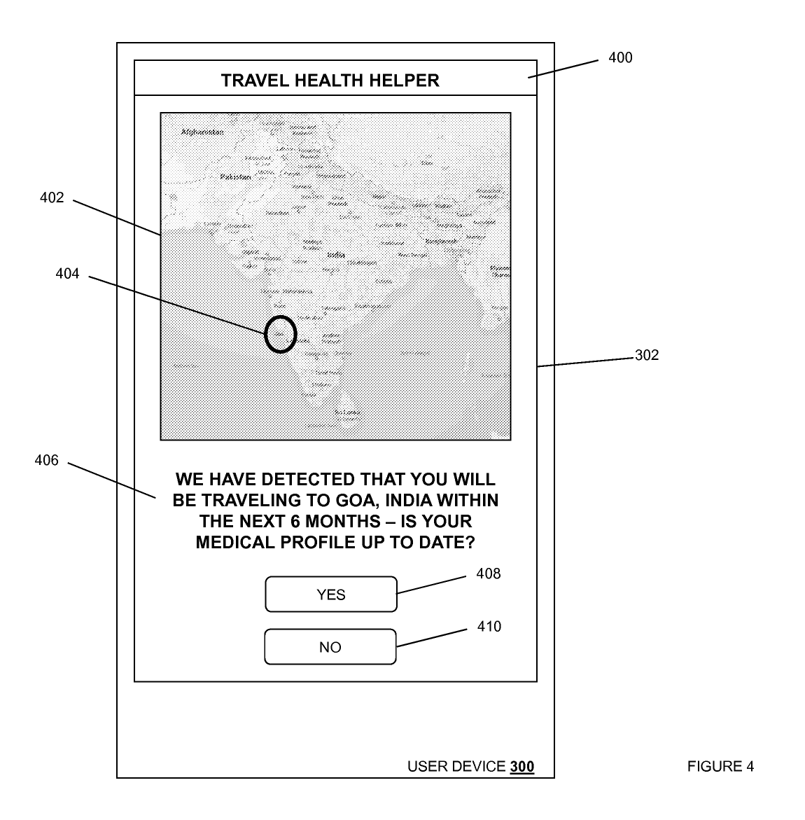

In some embodiments, the user may report (e.g., via their travel health management application or website using their user device) that they are traveling to a new location at block 104. However, the user does not need to report travel to the new location in the travel health management system 200, as the system may detect travel to the new location without any input from the user, just a few examples of which are provided below. As discussed below with reference to FIG. 4, when a user is determined to be traveling to a new location without input from the user, that travel to the new location may be confirmed with the user (e.g., if that determination was not in response to the user reporting that they will be traveling to the new location).

In an embodiment, the system provider device 202 may determine that a user is traveling to a new location at block 104 by reviewing a purchase history of the user. For example, when the system provider is a payment service provider as discussed above, the system provider device 202 may monitor a payment account or purchase history of the user to detect when travel related actions such as airline ticket purchases, train ticket purchases, hotel reservation purchases, rental car reservation purchases, event ticket purchases, and/or other travel related purchases are made by the user. Such travel related purchases may then be determined to be associated with a new location by, for example, determining a destination location of a purchased airline ticket or train ticket, determining a location of a purchased hotel reservation, determining a pickup location of a purchased rental car reservation, determining a location of an event associated with a purchased event ticket, and/or otherwise determining a location associated with the travel related purchase. In some embodiments, the system provider device 202 may then determine that that location is a new location if that location is more than a predetermined distance from the home location associated with the user. However, in other embodiments, any airline/train ticket destination and/or hotel reservation location may automatically be assumed to be a new location.

In some embodiments, the system provider device 202 may determine that a user is traveling to a new location at block 104 by analyzing information retrieved from the user device 208 of that user over the network 206. For example, the user device 208 of a user may include a calendar that includes the user's schedule, and the system provider device 202 may access and analyze that calendar to determine if the user is scheduled to travel to a new location away from their home location in the future (e.g., a user's calendar may include an entry “leave to Seattle”). Similarly, email messages, text messages, social media posts, and/or other communications by the user may be accessed by the system provider device 202 and analyzed to determine whether the user is planning on traveling to a new location in the future. For example, the system provider device 202 may access (e.g., via permissions provided by the user) the user's email applications, social media profiles, and/or other communication platforms, retrieve any of the communications between the user and others, and analyze those communications to determine whether the user is planning on traveling to a new location in the future.

In addition to determining that the user will be traveling to the new location at block 104, the system provider device 202 may determine a variety of other information associated with the user's travel plans to visit the new location at block 104. For example, the system provider device 202 may use the same information sources discussed above to determine the users' planned dates of the travel, the user's planned method of travel (e.g., by plane to the new location, and by bus once in the new location), the user's possible travel companions, activities the user may engage in while at the new location (e.g., jungle hiking, surfing, etc.), and/or any other information available about the user's travel plans to the new location. In some embodiments, the travel health management application or website provided by the system provider device 202 to the user device 208 may, once the user is detected as traveling to a new location, provide the user with a questionnaire or other information retrieval tool that requests details of the travel plans of the user. As such, the user may provide any additional travel plan information used by the system provider device 202, and/or may supplement the travel plan information retrieved by the system provider device as discussed above.

The method 100 then proceeds to block 106 where health situation information for the new location is retrieved. In an embodiment of block 106, the system provider device 202 uses the new location determined at block 104 to retrieve health situation information for the new location over the network 206. While a few examples of retrieving health situation information for the new location are described below, one of skill in the art in possession of the present disclosure will recognize that a wide variety of different methods for retrieving health situation information for a location will fall within the scope of the present disclosure.

In an embodiment, the system provider device 202 may access the location/treatment tracking system 212 over the network 206 and, using the new location determined at block 104, retrieve health situation information. For example, the location/treatment tracking system 212 may include a system controlled by a governmental entity (e.g., the Center for Disease Control and Prevention (CDC) in the United States) and that includes services exposed via application programming interfaces (APIs) that accept location information from the system provider device 202 (e.g., the new location) and return health situation information associated with health situations at the location associated with that location information. As is known in the art, the CDC and governmental entities like it are public health institutes that operate to protect public health and safety through the control and prevention of disease, focusing on infectious disease, food borne pathogens, environmental health, and/or other health situations. As such, those and other entities that provide the location/treatment tracking system(s) 212 may research, compile, and provide information on any health situation associated with any location that is collected and stored in their databases. While governmental entities providing the location/treatment tracking system 212 are discussed herein, non-governmental entities may research, compile, and provide the health situation information discussed herein while remaining within the scope of the present disclosure. In addition, the system provider device 202 may retrieve and store heath situation information for a plurality of locations from different health situation information providers (e.g., the governmental entities associated with each of the locations) such that that health situation information is available in a local database to the system provider device 202 at block 106.

In some embodiments, health situation information may be retrieved from news information sources and/or other health information reporting sources known in the art. For example, the system provider device 202 may access news information websites provided by news information providers, “scrape” data (e.g., extract data from human-readable output provided by the news information providers) from those news information websites, and analyze that scraped data to determine whether a health situation exists at a location. In other embodiments, the system provider may include employees that enter health situation information and its associated locations into a database that is accessible by the system provider device 202. In some embodiments, the system provider device 202 may analyze a calendar that is associated with historical occurrences of health situations in the new location to determine and retrieve the health situation information at block 106. For example, databases of time-based or date-based health situations (e.g., spikes in occurrences of malaria during summer months) in the new location may be accessed and, using the date that the user is planning on traveling to the new location, the system provider device may retrieve health situation information based on that date (i.e., the most common health situations existing during the dates that the user will be traveling to the new location).

In some embodiments, the health situation information may be determined based on medical profiles of other users. In one embodiment, the system provider device 202 may review medical profiles and other databases associated with other users in the travel health management system 200 to determine if they have recently traveled to the new location in order to determine whether those other users have experienced health issues subsequent to traveling to the new location. For example, the system provider device 202 may determine if the other users that previously traveled to the new location performed any health actions (e.g., received medical treatments, purchased medications, etc.) subsequent to traveling to the new location to determine whether those users experienced any negative health issues has a result of traveling to the new location. As such, the system provider device 202 may be able to detect whether health situations exist at a location based on the actions of users following their travel to that location (or their actions at that location that may have resulted in the health situation that they experienced).

The system provider device 200 may also retrieve any other information available about those users that previously traveled to the new location, including purchase histories, calendars, email communications, social media communications, location information, and/or a variety of other information that may be analyzed to determine whether those users experienced negative health effects as a result of their travel to the new location. As such, purchases of health situations remedies, cancelled calendar appointments that are indicative of a health situation (e.g., cancelling an entire day of appointments along with location information indicating the user did not leave their home), emails discussing a health situations, social media posts discussing a health situation, and/or any other information that indicates that the user experienced a health situation following traveling to the new location may be utilized by the system provider device 202 at block 106.

In an embodiment, the health situation information may include immunizations required or recommended in the new location (e.g., some countries may require or recommend particular immunizations to enter the country), diseases or sicknesses commonly contracted in the new location, recent outbreaks of diseases or other ailments in the new location, medications recommended in the new location, high risk activities in the new location, and/or a variety of other health situation information known in the art. While several examples of health situation information are discussed herein, information associated with any health situation at the new location that could affect the health of the user may be retrieved at block 106. For example, some health situation information may be user-specific, such as health situation information related to a planned trip into a high altitude area if the user is determined to have asthma, bacteria counts in a body of water that the user is planning to swim in, etc. As such, health situation information may be relevant to some users and not to others, and may be retrieved based on the determined travel plans of that user.

The method 100 then proceeds to block 108 where the health situation information for the new location retrieved at block 106 is compared to the medical profile of the user. In an embodiment, at block 108 the system provider device 102 retrieves the medical profile of the user that is traveling to the new location from the medical profile database at block 108. In some embodiments, upon determining that the user is traveling to the new location, the system provider device 102 may communicate with the user device 208 of the user to confirm that they are traveling to the new location and/or that their medical profile is up to date. For example, FIG. 4 illustrates an embodiment of the travel health management application or website on the user device 300 displaying a detection and confirmation screen 400 that includes a map 402, a location indicator 404 on the map that indicates the new location (e.g., Goa, India) to which the user may be traveling to, a detection message 406 informing the user they have been detected as planning on traveling to a new location and confirming whether their medical profile is up to date, along with a yes button 408 and a no button 410 that allows the user to indicate whether their medical profile is up to date (or to confirm their travel to the new location). While the detection and confirmation screen 400 allows a user to indicate that their medical profile may not be up to date (and subsequently update their medical profile via, for example, the traveling health reporting screen 304 illustrated in FIG. 3), in other embodiments, the system provider device 202 will have more information about the medical profile of the user than the user does themselves, and the need to confirm that the medical profile of the user is updated may be unnecessary. As such, the user may use the detection and confirmation screen 400 to simply confirm that the user is traveling to the new location determined at block 104.

The method 100 then proceeds to decision block 110 where it is determined whether a health action should be performed for the new location. In an embodiment, the comparing of the medical profile of the user with the health situation information for the new location at block 108 allows the system provider device 202 to determine whether any health actions should be performed by the user for the new location. For example, as discussed and illustrated below, the health situation information may indicate a variety of immunizations and medications that are required or recommended at the new location, and the comparing at block 108 will allow the system provider device 202 to determine at decision block 110 whether the previous vaccinations or immunizations received by the user, as well as medications recently purchased by the user, satisfy those requirements or recommendations. If it is determined at decision block 110 that health action does not need to be performed by the user for the new location, the method 100 proceeds to block 112 where that is reported to the user. As such, the user may be informed at block 112 that their medical profile indicates that they are ready to travel to the new location with no further action needed by them to deal with any determined health situations at the new location. If it is determined at decision block 110 that health action should be performed by the user for the new location, the method 100 proceeds to block 114 where a travel health recommendation is sent to the user. As such, the user may be provided one or more travel health recommendations at block 114 that recommend one or more health actions that should be performed by the user prior to traveling to the new location. As illustrated and described below, the method 100 may operate to perform blocks 112 and 114 concurrently (i.e., when the medical profile of the user indicates that the user is prepared for some health situations at the new location, but is not prepared with other health situations at the new location).

A number of examples will now be provided to illustrate how the method 100 may be utilized to manage the travel health of a user. However, those examples are not meant to be limiting, and one of skill in the art in possession of the present disclosure will recognize that any details discussed below may be combined with details discussed above to manage the travel health of a user.

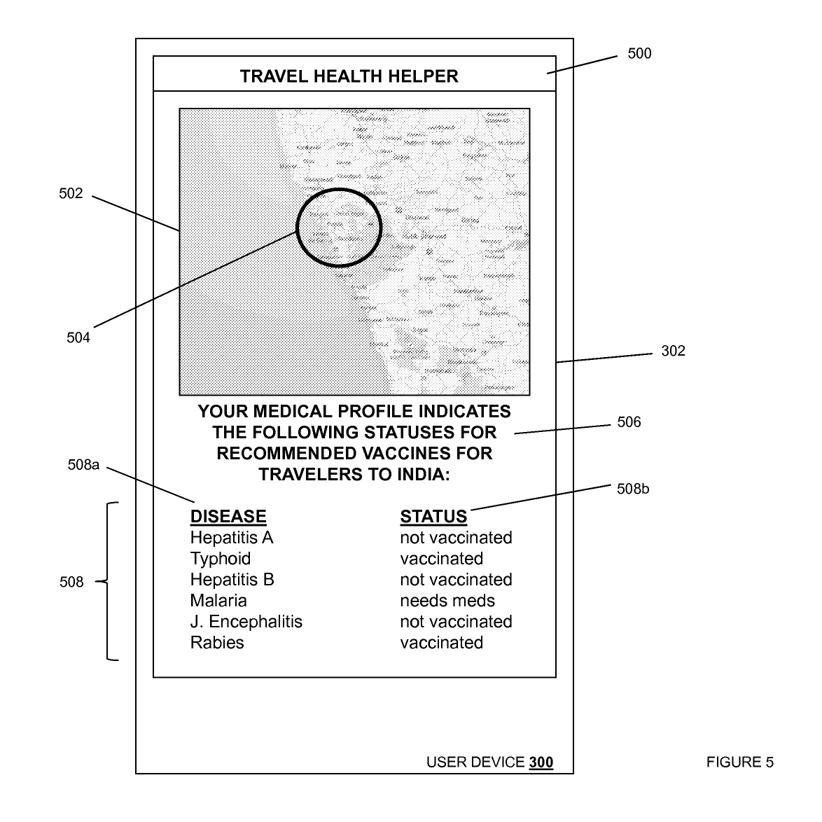

Referring now to FIG. 5, an embodiment of the travel health management application or website on the user device 300 displaying a travel health status screen 500 is illustrated. The travel health status screen 500 is an example of the performance of blocks 112 and 114 of the method 100 concurrently following the comparison at block 108 of the health situation information for the new location with the medical profile of the user, and the determination at decision block 110 that health actions should be performed by the user for the new location for some health situations and not for others. Continuing with the example provided in FIG. 4, the user has been detected as traveling to Goa, India, and in response, the system provider device 202 retrieved a plurality of health situation information from the location/treatment tracking systems 212 (e.g., the CDC) that includes a requirement/recommendation that people traveling to Goa, India (or in some cases, anywhere in India) have their hepatitis A vaccine, their typhoid vaccine, their hepatitis B vaccine, malaria medication, their Japanese Encephalitis vaccine, and their rabies vaccine. In the comparison of that health situation information to the medical profile of the user at block 108, the system provider device 202 may have determined that the user has not previously received or completed the hepatitis A vaccine, has previously received and completed the typhoid vaccine, has not previously received or completed the hepatitis B vaccine, has not purchased malaria medication, has not previously received or completed the Japanese Encephalitis vaccine, and has previously received and completed the rabies vaccine. In different embodiments, the system provider device may be able to determine whether previously received vaccines are up to date, complete, or otherwise have been performed such that they satisfy the medical requirements for the health situations determined at block 106. In addition, the determination of whether a health action is up-to-date may take into account the expiration of previous health actions. For example, the system provider device 202 may determine that a user's immunization for a health situation will expire during the planned travel dates to the new location, and thus a new health action may be recommended even though the user will be vaccinated for the health situation when the trip to the new location begins.

In an embodiment, the travel health status screen 500 is provided following blocks 112 and 114 of the method 100 and includes a map 502, a location indicator 504 on the map that indicates the new location (e.g., Goa, India) to which the user may be traveling to, and a health situation/medical profile analysis message 506 informing the user that their travel health status has been determined with regards to the current health situations determined at the new location. A status listing 508 may indicate the results of decision block 110 and includes the reporting at block 112 and travel health recommendations at block 114. As such, the user is informed that hepatitis A, typhoid, hepatitis B, malaria, Japanese Encephalitis, and rabies are health situations in the new location that are of concern in a disease column 508a of the status listing. In addition, a status column 508b in the status listing 508 informs the user that they have performed all the necessary health actions (i.e., received vaccinations in this case) for typhoid and rabies, but need to perform health actions (i.e., get vaccinations and medication) for hepatitis A, hepatitis B, malaria, and Japanese Encephalitis. In some embodiments, the user may be able to correct the information in the status column 508b by reporting updated status information to the system provider device 202 (e.g., by selecting the “malaria” indicator in the disease column 508a or the “needs meds” indicator in the status column 508b and indicating that the user has malaria medication in their possession).

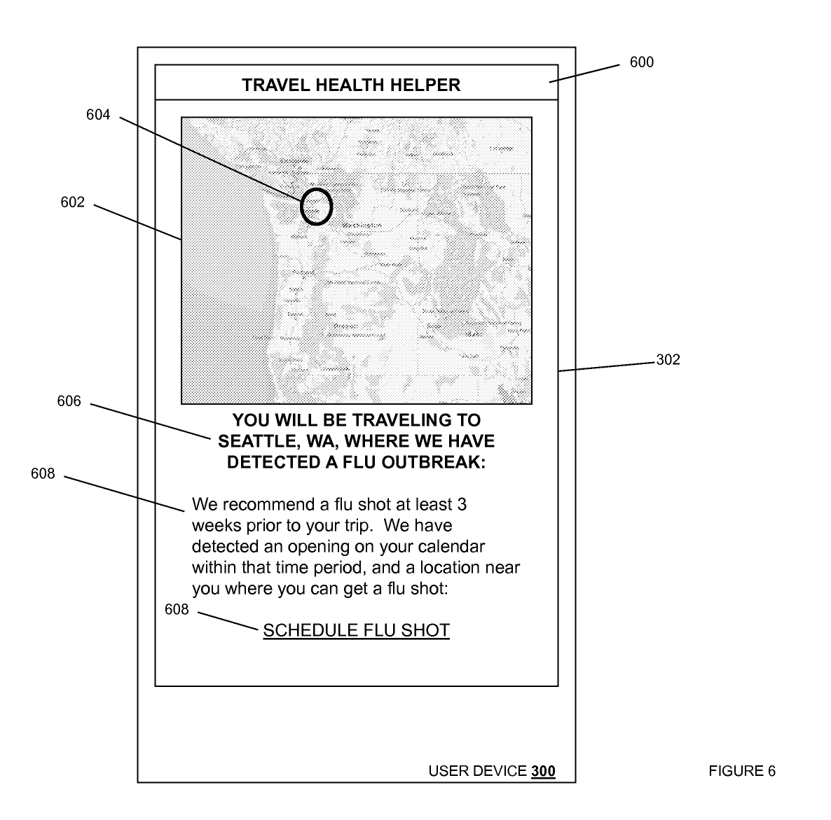

Referring now to FIG. 6, another embodiment of the travel health management application or website on the user device 300 displaying a travel health recommendation screen 600 is illustrated. The travel health recommendation screen 600 is an example of the performance of block 114 of the method 100 following the comparison at block 108 of the health situation information for the new location with the medical profile of the user, and the determination that a health action is needed by the user for the new location for a health situation. In this example, the user has been detected as traveling to Seattle, Wash., and in response, the system provider device 202 retrieved a plurality of health situation information from the location/treatment tracking systems 212 (e.g., scraping information for one or more local news sources in Seattle) that indicates that flu outbreak is occurring in Seattle. In the comparison of that health situation information to the medical profile of the user at block 108, the system provider device 202 may have determined that the user has not recently received or completed flu shots for the flu (or particularly strain of flue associated with the outbreak in Seattle). In different embodiments, the system provider device may be able to determine whether the user has recently purchased flu medication or other symptom reducing medicine such that they satisfy other medical requirements for the health situations determined at block 106.

In an embodiment, the travel health recommendation screen 600 is provided following block 114 of the method 100 and includes a map 602, a location indicator 604 on the map that indicates the new location (e.g., Seattle, Wash.) to which the user may be traveling to, and a health situation/medical profile analysis message 606 informing the user they that a health situation (a flu outbreak) has been detected at the new location. A travel health recommendation 608 indicates the results of decision block 110 and informs the user that a flu shot is recommended at least three weeks prior to their trip. In the illustrated embodiment, the system provider device 202 has accessed a calendar in the user device 208 of the user and determined time windows in the user's schedule that are free. The system provider device 202 has also accessed a flu shot provider in the home location (or current location) of the user, determined times at which flu shots may be purchased and received, and determined a match between those times and the free time windows in the user's calendar. As such, the travel health status screen 600 offers a health action scheduling link 610 that the user may select to automatically schedule a health action (e.g., a flu shot) to prepare for the health situation at the new location. While actions by the system provider device 202 have been described that allow a link to be selected to automatically schedule the health action for the user, the user may be linked to a variety of medical service providers to schedule their own health action while remaining within the scope of the present disclosure.

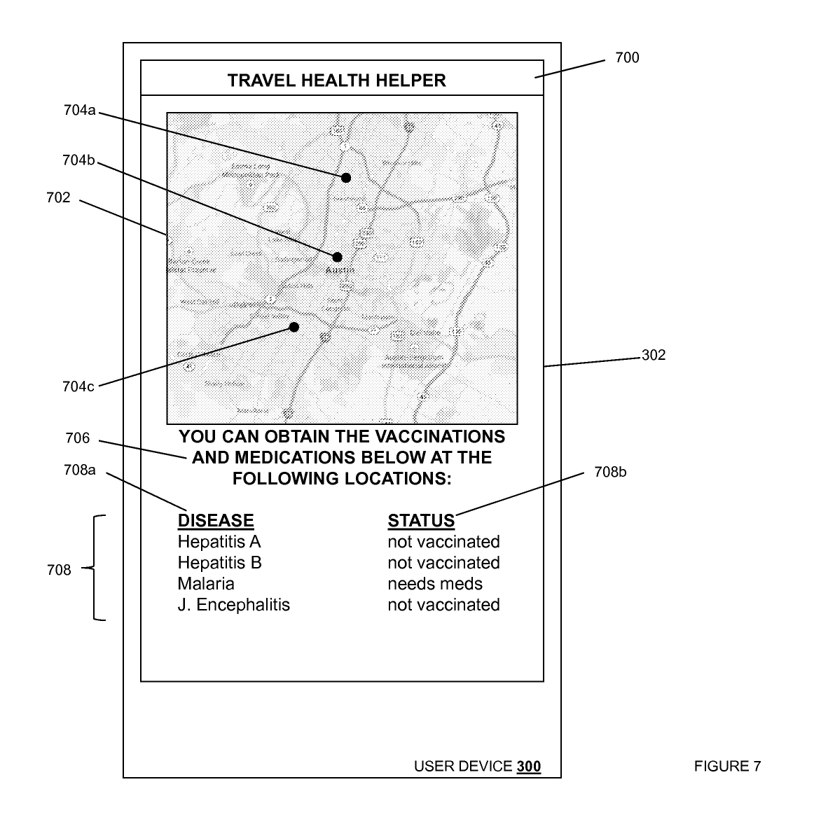

For example, referring now to FIG. 7, an embodiment of the travel health management application or website on the user device 300 displaying a travel health recommendation screen 700 is illustrated. The travel health recommendation screen 700 may be provided following the travel health status screen 500 of FIG. 5. The travel health recommendation screen 700 includes a map 702 (e.g., of the users home location or current location), a plurality of medical service provider indicators 704a, 704b, and 704c on the map that indicate the locations in the user's home or current location at which the user can perform the recommendation health action, and a health action location message 706 informing the user that locations have been retrieved where they can perform health actions to prepare for their trip to the new location. A status listing 708 includes a disease column 708a that lists the health situations for which the user is recommended to perform a health action, and a status column 708b that indicates the current status of the user with regard to those health situations. In an embodiment, for each health action recommended to the user, the system provider device 202 may determine one or more locations of medical service providers that are within a predetermined distance from the home or current location of the user and that provide medical services that allow for the performance of those health actions, and provide those locations to the user. In some embodiments, the system provider device 202 may rank those locations by factor such as, for example, current distance from the user, locations that provide more of the recommended health action relative to locations that provide only one of the recommended health actions, user reviews of the locations, etc. (e.g., a location that performs all of the recommended health actions may be ranked higher than a location that provides just one health action, particularly if that location is closer to the user than other locations). In some embodiments, the locations may be filtered by their ability to allow the user to perform the health action prior to traveling to the new location (or a sufficient time prior to traveling to the new location). In some embodiments, the locations may be filtered based on whether they accept the user's medical insurance (e.g., as retrieved from the medical profile of the user).

As discussed above, locations of medical service providers recommended to a user to perform a health action may be at a user's home location or a user's current location. As such, travel health recommendations to perform health actions may be made at any location that the user is currently located at. This allows a user that is traveling regularly (or that is currently traveling) to prepare for future travel regardless of whether the user is in their home location or currently traveling. Furthermore, the system provider device may schedule out a health action that may take a period of time (e.g., a vaccination schedule that may take several weeks) such that the user may be recommended to perform a first health action in a first location (e.g., their home location) and at least one second action in a second location (e.g., a current location that the user has traveled to) in order to ensure that the user is properly preparing for their trip to the new location. Whether scheduled all in their home location or in different current locations, the scheduling out of a health action allows the system provider device 202 to provide a health action schedule to the user that ensures the performance of the health action prior to travel to the new location, and in many cases to ensure that the health action is performed with a lead time prior to the travel to the new location such that it is effective (or most effective).

While several examples of travel health recommendations have been described in which a user is recommended health actions to perform to prepare to travel to a new location based on immunizations required or recommended at the new location and/or disease outbreaks at the new location, other health situations may result in travel health recommendations while remaining within the scope of the present disclosure. In an embodiment, a determination may be made that a user will be performing an activity at the new location that is associated with a health situation that people not performing that activity are not subject to, and the system provider device 202 may provide a travel health recommendation to the user for that health situation. For example, if a user is planning on swimming in a body of water at the new location that may be currently associated with a high bacterial count, a travel health recommendation may be made to purchase medicine or receive an inoculation to counteract the possible effects of the bacteria. Similarly, if the user is planning on surfing at the new location, and weather information retrieved by the system provider device 202 indicates that the new location is scheduled to receive a storm that may wash bacteria into the water, similar travel health recommendations may be provided.

In addition to recommending health actions that the user may perform to prepare for traveling to the new location, the travel health management system 200 may provide a number of other benefits. For example, the system provider device 202 may track the users performance of the health actions recommended to the user in the travel health recommendation, and may provide updates to the user so that the user is informed of the current status of their medical profile and/or preparation with regard to traveling to the new location. Such tracking of the performance of user health actions may include monitoring of the payment account or purchase history of the user to determine whether the user has paid for medical or other health services, purchased medications, and/or performed other payment actions that are indicative of the performance of the recommended health actions.

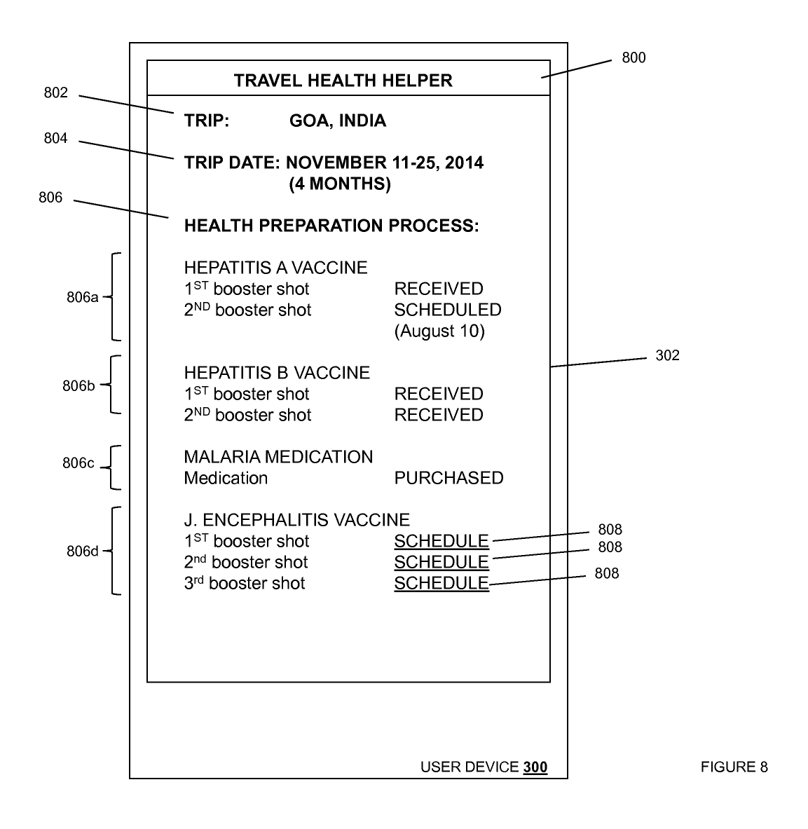

FIG. 8 illustrates an embodiment of the travel health management application or website on the user device 300 displaying a travel health status update screen 800 that provides the user updates about their medical profile with regard to the health situation at the new location that they are traveling to. The travel health status update screen 800 includes the new location 802, a travel date 804, and a health preparation section 806 that include a plurality of health action statuses 806a, 806b, 806c, and 806d. In the illustrated embodiment, the health action status 806a indicates a status of a hepatitis A vaccine, which the system provider device 202 has determined requires two booster shots, one of which has been received by the user, and one of which is scheduled in the future. The health action status 806b indicates a status of a hepatitis B vaccine, which the system provider device 202 has determined requires two booster shots, each of which has been received by the user. The health action status 806c indicates a status of malaria medication, which the system provider device 202 has determined has been purchased by the user. The health action status 806d indicates a status of a Japanese Encephalitis vaccine, which the system provider device 202 has determined requires three booster shots, none of which has been received by the user, but each of which may be scheduled with a medical services provider in the user's home or current location via links 808 in the health action status 806d. As such, the system provider device 202 may provide a schedule for completing a health action (e.g., a schedule for performing a plurality of shots for a vaccination) prior to the travel date when the user is to travel to the new location (and in some cases with a sufficient lead time prior to the travel date to ensure the effectiveness of the health action). Such scheduling of health actions may include an analysis of a user's calendar to determine when the user is available to perform the health actions based on previous commitments, and an automatic scheduling and adding to the user's calendar of that scheduled appointment.

Thus, the user may receive and/or review the travel health status update screen 800 to monitor their preparation for the health situations at the new location to which they'll be traveling, determine which health actions are scheduled to be performed in the future, schedule health actions that need to be performed in the future, and/or otherwise manage their travel health with regard to their scheduled trip to the new location in the future. In some embodiments, the user may update the statuses if the user has performed those health actions but the performance of those actions has not been detected by the system provider device 202. Any health actions performed or reported by the user may be detected by the system provider device 202, used to update the travel health update screen 800, and used to update the medical profile of the user in the medical profile database 204.

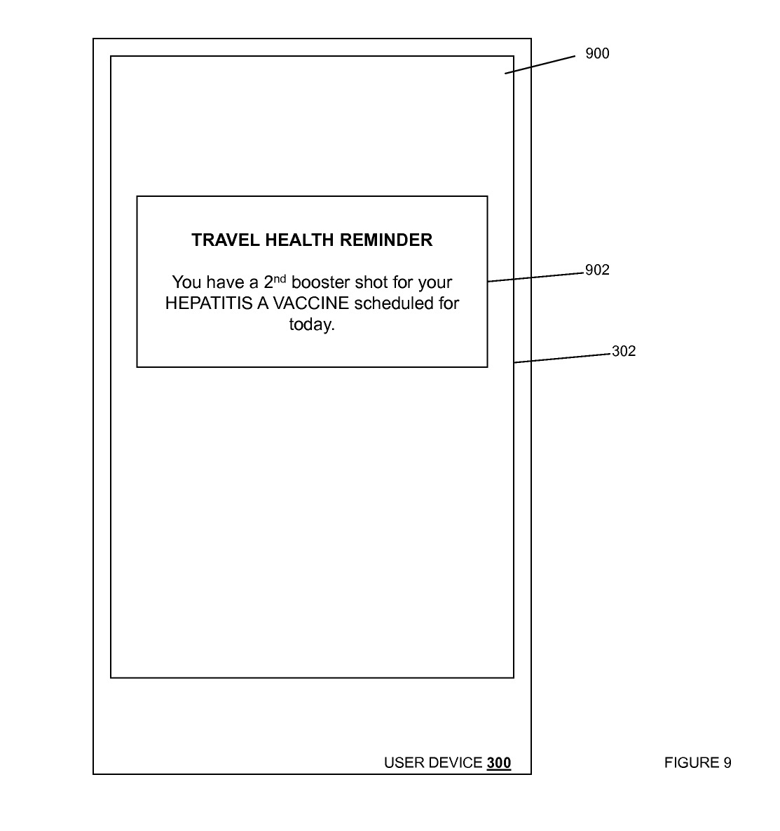

In addition to allowing a user to track and monitor their recommended health actions for preparing to travel to the new location, the travel health management system 200 may also provide reminders to users to perform health actions that have been recommended to them. For example, FIG. 9 illustrates an embodiment of the travel health management application or website on the user device 300 displaying a travel health action reminder screen 900 that, in the illustrated embodiment, includes a pop-up window 902 that provides a travel health reminder that reminds the user that they have a scheduled health action which includes a second booster shot for a hepatitis A vaccine scheduled. In some embodiments, the system provider device 202 may determine that a health action that was recommended to a user has not been completed by the user and is scheduled with a medical services provider within a predetermined amount of time and, in response, provide the travel health action reminder screen 900 to the user.

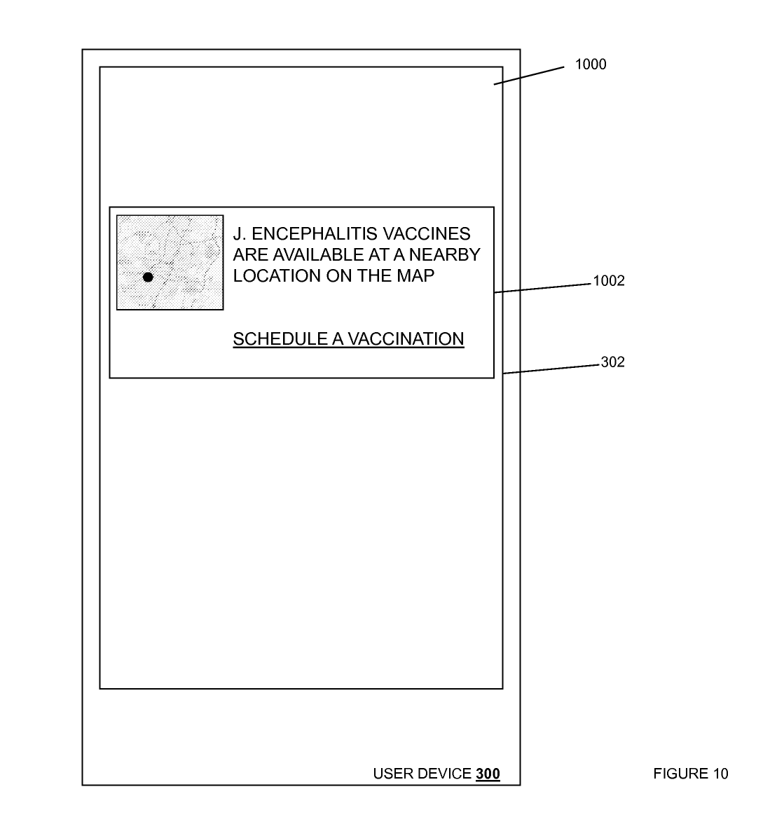

In another example, FIG. 10 illustrates an embodiment of the travel health management application or website on the user device 300 displaying a travel health action suggestion screen 1000 that, in the illustrated embodiment, includes a pop-up window 1002 that provides a travel health suggestion that suggests to the user that they schedule a Japanese Encephalitis vaccination at a nearby location, along with providing a link to schedule that health action. For example, the system provider device 202 may monitor the location of the user device 300 (e.g., via location information periodically sent by the user device 300 to the system provider device 202) and, if the user device comes within a predetermined distance from a medical services provider that provides a health action that the user has been recommended to perform in preparation for traveling to the new location, the system provider device 202 may provide the travel health suggestion screen 1000 for display on the user device 300. As such, the travel health recommendation system 200 may track the performance of the recommended health actions by the user and, for recommended health actions that have not been performed, use the current location of the user to determine locations of medical services providers where that health action may be performed and periodically report the locations of those medical services providers to the user.

Thus, systems and methods for managing the travel health of a user have been described that automatically detect when a user is traveling to a new location away from their home location, retrieve health situation information associated with that new location, and compare that health situation information to a medical profile of the user to determine if any health actions should be performed by the user to prepare for traveling to the new location. If there are health actions that should be performed by the user, a travel health recommendation is provided to the user that recommends the performance of those health actions. The systems and methods may manage the travel health of the user by finding locations in or around the user's home or current location where the user may perform those health actions, and even schedule appointments to have those health actions performed. The systems and methods track the performance of such health actions, and may provide reminders to the user to perform scheduled health actions or schedule such health actions in time for performance prior to traveling to the new location. As such, the management of travel health by a user is greatly simplified, and ensures that the user will be as prepared as possible for any trip to a new location.

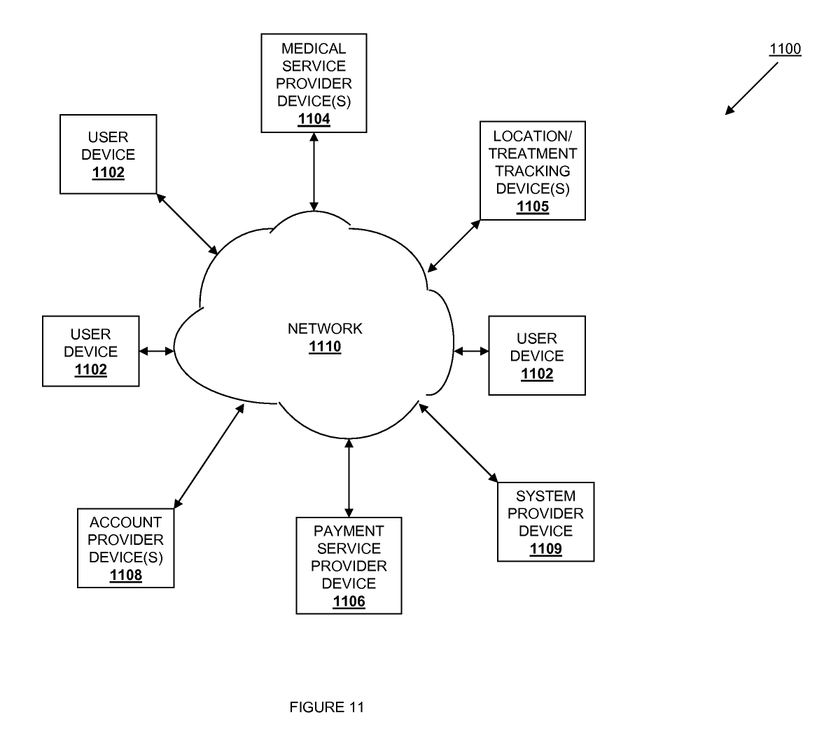

Referring now to FIG. 11, an embodiment of a network-based system 1100 for implementing one or more processes described herein is illustrated. As shown, network-based system 1100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 11 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1100 illustrated in FIG. 11 includes a plurality of user devices 1102, a plurality of medical service provider devices 1104, a plurality of location/treatment tracking device(s) 1105, a payment service provider device 1106, a plurality of account provider devices 1108, and/or a system provider device 1109 in communication over a network 1110. Any of the user devices 1102 may be the user devices, discussed above. The medical service provider devices 1104 may be the medical service provider devices discussed above and may be operated by the medical service providers discussed above. The location/treatment tracking device(s) 1105 may be the location/treatment tracking devices discussed above and may be operated by the location/treatment tracking systems discussed above. The payment service provider device 1106 may be the payment service provider devices discussed above and may be operated by a payment service provider such as, for example, PayPal Inc. of San Jose, Calif. The account provider devices 1108 may be the account provider devices discussed above and may be operated by the account providers discussed above such as, for example, credit card account providers, bank account providers, savings account providers, and a variety of other account providers known in the art. The system provider device 1109 may be the system provider device discussed above and may be operated by the system providers discussed above.

The user devices 1102, medical service provider devices 1104, location/treatment tracking device(s) 1105, payment service provider device 1106, account provider device 1108, and/or system provider device 1109 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1100, and/or accessible over the network 1110.

The network 1110 may be implemented as a single network or a combination of multiple networks. For example, in various embodiments, the network 1110 may include the Internet and/or one or more intranets, landline networks, wireless networks, and/or other appropriate types of networks.

The user device 1102 may be implemented using any appropriate combination of hardware and/or software configured for wired and/or wireless communication over network 1110. For example, in one embodiment, the user device 1102 may be implemented as a personal computer of a user in communication with the Internet. In other embodiments, the user device 1102 may be a smart phone, personal digital assistant (PDA), laptop computer, and/or other types of computing devices.

The user device 1102 may include one or more browser applications which may be used, for example, to provide a convenient interface to permit the user to browse information available over the network 1110. For example, in one embodiment, the browser application may be implemented as a web browser configured to view information available over the Internet.

The user device 1102 may also include one or more toolbar applications which may be used, for example, to provide user-side processing for performing desired tasks in response to operations selected by the payer. In one embodiment, the toolbar application may display a user interface in connection with the browser application.

The user device 1102 may further include other applications as may be desired in particular embodiments to provide desired features to the user device 1102. In particular, the other applications may include a payment application for payments assisted by a payment service provider through the payment service provider device 1106. The other applications may also include security applications for implementing user-side security features, programmatic user applications for interfacing with appropriate application programming interfaces (APIs) over the network 1110, or other types of applications. Email and/or text applications may also be included, which allow the user to send and receive emails and/or text messages through the network 1110. The user device 1102 includes one or more user and/or device identifiers which may be implemented, for example, as operating system registry entries, cookies associated with the browser application, identifiers associated with hardware of the user device 1102, or other appropriate identifiers, such as a phone number. In one embodiment, the user identifier may be used by the payment service provider device 1106 and/or account provider device 1108 to associate the user with a particular account as further described herein.

The medical service provider devices 1104 may be maintained, for example, by a medical service provider offering various medical products and/or services in exchange for payment to be received conventionally or over the network 1110. In this regard, the medical service provider devices 1104 may include a database identifying available products and/or services (e.g., collectively referred to as items) which may be made available for viewing and purchase by the user.

The medical service provider devices 1104 also include a checkout application which may be configured to facilitate the purchase by the payer of items. The checkout application may be configured to accept payment information from the user through the user device 1102, the account provider through the account provider device 1108, and/or from the payment service provider through the payment service provider device 1106 over the network 1110.

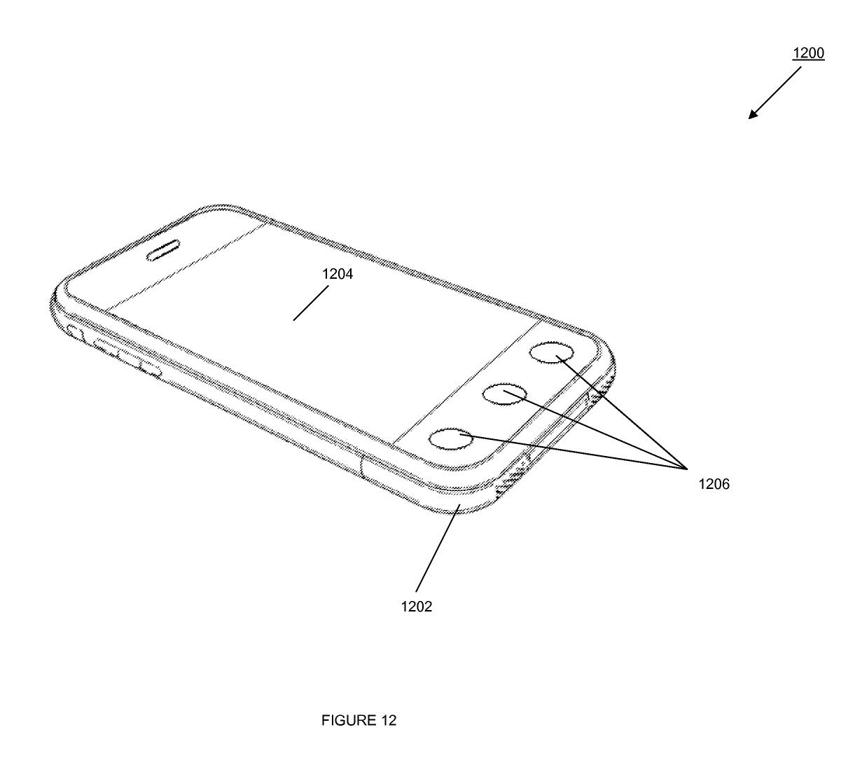

Referring now to FIG. 12, an embodiment of a user device 1200 is illustrated. The user device 1200 may be the user devices discussed above. The user device 1200 includes a chassis 1202 having a display 1204 and an input device including the display 1204 and a plurality of input buttons 1206. One of skill in the art will recognize that the user device 1200 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

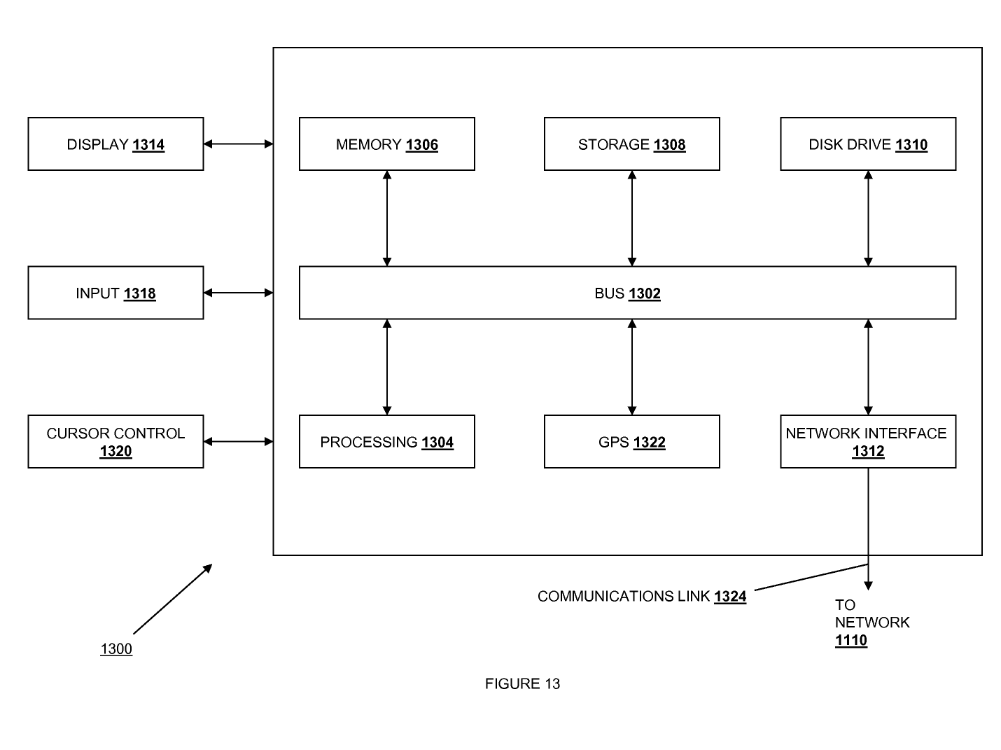

Referring now to FIG. 13, an embodiment of a computer system 1300 suitable for implementing, for example, user devices 1102, medical service provider devices 1104, location/treatment tracking device(s) 1105, payment service provider device 1106, account provider device 1108, and/or system provider device 1109, is illustrated. It should be appreciated that other devices utilized by uses, medical service providers, location/treatment tracking systems, payment service providers, account providers, and/or system providers in the travel health management system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), a cursor control component 1320 (e.g., mouse, pointer, or trackball), and/or a location determination component 1322 (e.g., a Global Positioning System (GPS) device as illustrated, a cell tower triangulation device, and/or a variety of other location determination devices known in the art.) In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the user devices 1102, medical service provider devices 1104, location/treatment tracking device(s) 1105, payment service provider device 1106, account provider device 1108, and/or system provider device 1109. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1110 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

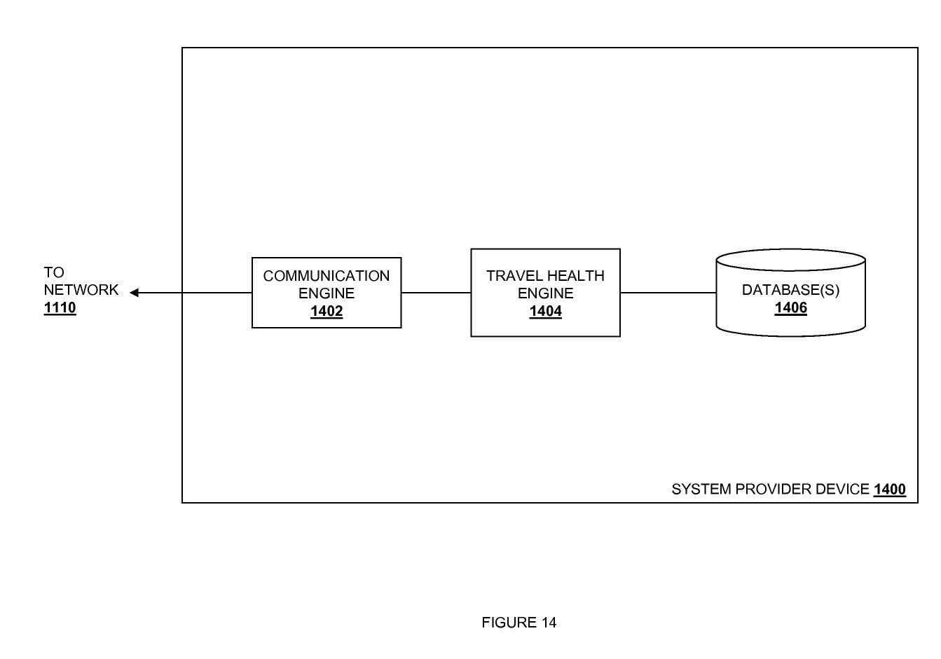

Referring now to FIG. 14, an embodiment of a system provider device 1400 is illustrated. In an embodiment, the device 1400 may be any of the system provider devices discussed above. The device 1400 includes a communication engine 1402 that is coupled to the network 1110 and to a travel health engine 1404 that is coupled to a database 1406. The communication engine 1402 may be software or instructions stored on a computer-readable medium that allows the device 1400 to send and receive information over the network 1110. The transportation health engine 1404 may be software or instructions stored on a computer-readable medium that is configured to determine a user is traveling to a new location, retrieve health situation information, compare health situation information to a user medical profile stored in the database 1406, provide travel health recommendations, provide travel health reminders, and provide any of the other functionality that is discussed above. While the database 1406 has been illustrated as located in the system provider device 1400, one of skill in the art will recognize that it may be connected to the travel health engine 1404 through the network 1110 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A travel health management system, comprising:
a non-transitory memory storing a medical profile for a user;
one or more hardware processors coupled to the memory and configured to read instructions from the memory to perform the steps of:
determining that the user will be traveling to a new location that is different from a home location that is associated with the user;
retrieving health situation information that is associated with at least one health situation at the new location;
comparing the health situation information to the medical profile for the user to determine a travel health recommendation that includes a health action that will prepare the user for the at least one health situation at the new location; and
providing the travel health recommendation for display to the user.

2. The system of claim 1, wherein the one or more hardware processors are configured to read instructions from the memory to perform the steps of:
tracking a status of the performance of the heath action by the user; and
providing an update of the status for display to the user.

3. The system of claim 1, wherein the one or more processors are configured to read instructions from the memory to perform the steps of:
determining a first location at which the health action may be performed by the user, wherein the first location is within a predetermined distance of the home location; and
providing the first location for display to the user.

4. The system of claim 1, wherein the one or more processors are configured to read instructions from the memory to perform the steps of:
determining that the health action has not been completed by the user; and
providing a travel health recommendation reminder for display to the user.

5. The system of claim 1, wherein the one or more hardware processors are configured to read instructions from the memory to perform the steps of:
compiling the medical profile for the user; and
storing the medical profile for the user in the non-transitory memory.

6. The system of claim 5, wherein the medical profile for the user is compiled at least in part using a purchase history of the user.

7. A method for providing travel health management, comprising:
determining, by a system provider device in communication with a user device, that a user associated with the user device will be traveling to a new location that is different from a home location that is associated with the user in a database;
retrieving, by the system provider device from at least one location/treatment tracking system, health situation information that is associated with at least one health situation at the new location;
comparing, by the system provider device, the health situation information to a medical profile for the user that is stored in the database to determine a travel health recommendation that includes a plurality of health actions that will prepare the user for the at least one health situation at the new location; and
providing, by the system provider device, the travel health recommendation for display on the user device.

8. The method of claim 7, further comprising:
tracking, by the system provider device, a status of the performance of the plurality of health actions by the user; and
providing, by the system provider device, an update of the status for display to the user.

9. The method of claim 8, wherein the determining that the user associated with the user device will be traveling to a new location further comprises:
retrieving, by the system provider device from the user device, a calendar that is associated with the user; and
determining that the calendar includes a scheduled trip to the new location.

10. The method of claim 7, further comprising:
determining, by the system provider device, that at least one of the plurality of health actions has not been completed by the user; and
providing, by the system provider device for display on the user device, a health action reminder for the at least one of the plurality of health actions has not been completed by the user.

11. The method of claim 7, further comprising:
receiving, by the system provider device, a purchase associated with a health action performed by the user; and
storing, by the system provider device, the health action as part of the medical profile for the user in the database.

12. The method of claim 7, further comprising:
receiving, by the system provider device, a user travel documentation identifier from the user device; and
associating, by the system provider device, the user travel documentation identifier with the medical profile for the user in the database.

13. The method of claim 12, further comprising:
receiving, by the system provider device from governmental entity device over the network, a request for the medical profile for the user, wherein the request includes the user travel documentation identifier; and
providing, by the system provider device to the governmental entity device over the network, the medical profile for the user.

14. A non-transitory computer-readable medium comprising instructions which, in response to execution by a computer system, cause the computer system to perform a method comprising:
determining that a user will be traveling to a new location that is different from a home location that is associated with the user in a database;
retrieving health situation information that is associated with at least one health situation at the new location;
comparing the health situation information to a medical profile for the user that is stored in the database to determine a travel health recommendation that includes a health action that will prepare the user for the at least one health situation at the new location; and
providing the travel health recommendation for display to the user.

15. The non-transitory machine-readable medium of claim 14, wherein the method further comprises:
tracking a status of the performance of the heath action by the user; and
providing an update of the status for display to the user.

16. The non-transitory machine-readable medium of claim 14, wherein the method further comprises:
retrieving a travel date that the user will be traveling to the new location;
determining a plurality of locations at which the health action may be completed by the user prior to the travel date, wherein each of the plurality of locations are within a predetermined distance of the home location; and
providing the plurality of locations for display to the user.

17. The non-transitory machine-readable medium of claim 14, wherein the method further comprises:
providing a schedule for completing the health action prior to the travel date for display to the user.

18. The non-transitory machine-readable medium of claim 14, wherein the method further comprises:
determining the health situation information that is associated with the at least one health situation at the new location using a plurality of other medical profiles that are associated with other users that have previously traveled to the new location; and
storing the health situation information.

19. The non-transitory machine-readable medium of claim 18, wherein the health situation information that is determined using the plurality of other medical profiles that are associated with the other users includes at least one health action taken by the plurality of other users subsequent to traveling to the new location.

20. The non-transitory machine-readable medium of claim 14, wherein the method further comprises:
receiving a user travel documentation identifier from the user device;
associating the user travel documentation identifier with the medical profile for the user in the database;
receiving a request for the medical profile for the user from a governmental entity device over the network, wherein the request includes the user travel documentation identifier; and
providing the medical profile for the user over the network to the governmental entity device.
